(19) United States
(12) Patent Application Publication
(10) Pub. No.: US 2014/0144041 A1
(43) Pub. Date: May 29, 2014

(54) SYSTEM FOR ABSORBING CONDENSATION FROM COLD FOOD AND BEVERAGE CONTAINERS

(71) Applicant: JANE JEAN-BARNARD, FAYETTEVILLE, NC (US)

(72) Inventor: JANE JEAN-BARNARD, FAYETTEVILLE, NC (US)

(21) Appl. No.: 13/689,015

(22) Filed: Nov. 29, 2012

(51) Int. Cl. F26B 5/16

(52) U.S. Cl. CPC F26B 5/16
USPC 34/355; 34/95

(57) ABSTRACT

The present invention relates to a system for absorbing condensation from cold food and beverage containers wherein a cloth comprising polyester, rayon and spandex is wrapped around the cold object. It can be used to wrap juice containers, food containers, and the like to prevent condensation in a closed environment from wetting other dry objects in the environment.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a system and method for controlling condensation on cold food and beverage containers, specifically a particular fabric material that is found to be superior at wicking and absorbing condensation.

2. Description of Related Art

In most cases, when cold food and beverage containers are removed from the freezer or refrigerator, they will quickly produce condensation (“sweating”) on their surface. Where the container is placed near other items such as food, clothing, water, sensitive surfaces, and objects (e.g. wood), the condensation can ruin, make inedible, or otherwise damage things next to them. This is a problem with juice containers, milk containers, or the like that are placed in lunch boxes or the like in their sealed container which have no means for controlling condensation and can easily ruin a sandwich or other food items in the lunch box.

Condensation has been controlled by a number of expensive or hard to use devices. For example, insulated thermos style beverage containers help control condensation but are extremely expensive. Koozies wrap around beverage containers but the materials used for them are only marginally effective if wrapped tightly around the container and poor if only laid next to the container. Koozies are mostly effective for protecting the hands from the temperature of the container, needs to be shaped to the particular container it is being used with, and takes time and effort to place on the container.

Currently there is no system for merely placing something with the container to wick and absorb the sweat from such containers.

### BRIEF SUMMARY OF THE INVENTION

It has been discovered the above problems can easily be rectified by placing a piece of fabric consisting essentially of about 58% polyester, about 40% rayon, and about 2% spandex next to or on the container for allowing it to absorb the sweat.

Accordingly, one embodiment of the invention is a system for controlling condensation on a cold food or beverage container comprising a piece of fabric consisting essentially of about 58% polyester, about 40% rayon, and about 2% spandex placed in contact with the container.

In another embodiment there is a method of controlling condensation on a cold food or beverage container comprising positioning a piece of fabric consisting essentially of about 58% polyester, about 40% rayon, and about 2% spandex in contact with the container.

### BRIEF DESCRIPTION OF THE DRAWINGS

FIG. 1 is a perspective view of an embodiment showing a beverage container in a lunch box with the fabric of the invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The term “comprising” is not intended to limit inventions to only claiming the present invention with such comprising language. Any invention using the term comprising could be separated into one or more claims using “consisting” or “consisting of” claim language and is so intended.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawing featured in the FIGURE is for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein “controlling condensation” refers to absorbing, wicking, soaking up, dissipating, or otherwise holding condensation from a food or beverage container that is colder than the surrounding environment, and thus condensing water on its surface. In one embodiment the container is a chilled beverage container. In other embodiments the container is a chilled drink bottle, yogurt, juice box or bottle, sports drink bottle, jug, or the like.

The “piece of fabric” as used herein consists essentially of fabric comprising about 58% polyester, about 40% rayon, and about 2% spandex. This fabric has very specific and superior properties to other types of wicking absorbing materials previously utilized. As seen in the example, several materials were tested and the fabric of the invention proved far superior to the previously utilized materials. The fabric is utilized alone but can be dyed a desired color or can be imprinted with a desired message or advertisement. The material is machine washable.

The material is utilized by wrapping, laying, or placing the piece of fabric on or around the container to which moisture is to be controlled. In one embodiment it is placed around a liquid drink container which is then placed in a lunch box, e.g. a juice container that is chilled.

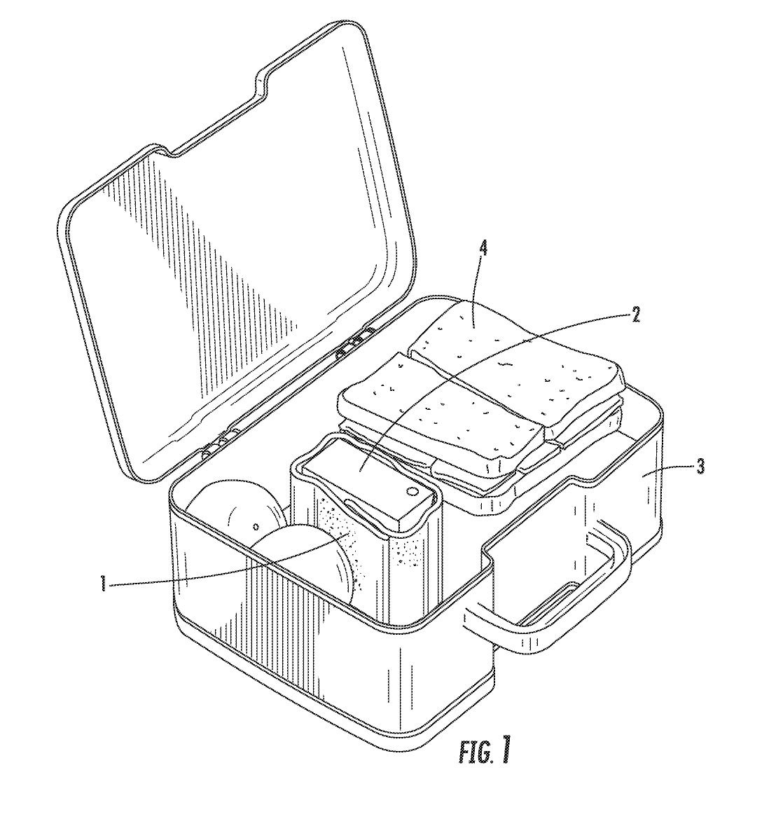

Now referring to the FIGURE, FIG. 1 depicts an embodiment of the present invention. In this view a piece of fabric 1 of the present invention is wrapped against chilled beverage container 2 and is sitting in lunch box 3 also containing a sandwich 4. Because the fabric 1 is wicking and absorbing condensation, the sandwich is protected from getting wet and ruined. One viewing this embodiment can easily see how other embodiments would be utilized.

### Experiment 1

The present fabric of the invention was tested in a lunch box against fleece, cotton, spandex alone, nylon alone, rayon, polyester sock material, insulating foam, and combinations of these utilized with a refrigerated drink carton and compared to pieces of fabric of the same general size and shape. In all cases the material of the present invention out performed and kept dry the interior of the lunch box. The size of the fabric was about 12 inches by 18 inches.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for controlling condensation on a cold food or beverage container consisting of a piece of fabric consisting essentially of about 58% polyester, about 40% rayon, and about 2% spandex placed in contact with the container.

2. A system according to claim 1 wherein there is printing on the piece of fabric.

3. A system according to claim 1 wherein the container is a beverage container positioned in a carry case.

4. A method of controlling condensation on a cold food or beverage container consisting of positioning a piece of fabric consisting essentially of about 58% polyester, about 40% rayon and about 2% spandex in contact with the container.
